(19) United States
(12) Patent Application Publication
(10) Pub. No.: US 2006/0110719 A1
(43) Pub. Date: May 25, 2006

(54) Educational tools and methods for demonstrating enhanced performance characteristics of a textile product to a person

(75) Inventors: Renee DeLack Hultin, Greensboro, NC (US); Christy C. Joyce, High Point, NC (US); Mark A. Brutten, San Francisco, CA (US); Kimberly S. Houchens, Emeryville, CA (US)

Correspondence Address: MORRISON & FOERSTER LLP, 755 PAGE MILL RD, PALO ALTO, CA, 94304-1018, US

(73) Assignee: Nano-Tex, Inc., Emeryville, CA (US)

(21) Appl. No.: 11/065,517

(22) Filed: Feb. 23, 2005

Related U.S. Application Data
(60) Provisional application No. 60/608,065, filed on Sep. 7, 2004.

(51) Int. Cl. G09B 25/00

(52) U.S. Cl. 434/365

(57) ABSTRACT

The present invention relates to educational tools and methods for teaching individuals, and in particular consumers, about the enhanced performance characteristics of textile products. In accordance with the present invention, the enhanced performance characteristics are typically invisible to the naked eye, however the effects of these enhanced performance characteristics can be easily visualized when challenged. Accordingly, such educational tools and methods are necessary to demonstrate the enhanced performance characteristics of the textile products that would otherwise be impossible to recognize.

### CROSS REFERENCE TO RELATED APPLICATIONS

This application claims priority to provisional application U.S. Ser. No. 60/608,065, which was filed on Sep. 7, 2004.

### TECHNICAL FIELD

The present invention relates to educational tools and methods for teaching individuals, and in particular consumers, about the enhanced performance characteristics of textile products. In accordance with the present invention, the enhanced performance characteristics are typically invisible to the naked eye, however the effects of these enhanced performance characteristics can be easily visualized when challenged. Accordingly, such educational tools and methods are necessary to demonstrate the enhanced performance characteristics of the textile products that would otherwise be impossible to recognize.

### BACKGROUND OF THE INVENTION

Consumer education is of paramount importance in ensuring the health and comfort of the purchasing public, as well as ensuring that purchases are made based on actual knowledge about products and not solely on emotion. The popularity of the phrase “consumer beware” is an indication that today's consumers must be vigilant in protecting themselves against unscrupulous sales tactics. Since textile products represent a very large percentage of the goods purchased by average consumers, it is important to make sure consumers are aware of the performance characteristics of such products before making a decision to purchase.

Gaining knowledge about the characteristics of textile products usually involves reading print materials describing the products and the characteristics associated therewith. However, many consumers are not able to easily comprehend complicated technical data describing consumer products, and can't reliably identify what is meaningful to them. For this reason, many consumers rely only on a visual inspection of the products prior to purchasing, and are thus susceptible to misunderstandings about the performance characteristics of such products. This often results in purchasing products that either overperform or underperform relative to a consumer's expectations and needs.

Accordingly, there is a need to provide educational tools and methods for demonstrating the performance characteristics of textile products in a manner that is easily comprehended.

### SUMMARY OF THE INVENTION

The present invention relates to educational tools for demonstrating the performance characteristics of textile products. More particularly, the educational tool includes a textile sample having the same enhanced performance characteristic as the textile product, and a description of the enhanced performance characteristic. By allowing a person to use the educational tool by subjecting the textile sample to an external environmental challenge, it enables them to visualize the performance of the textile sample, and thus learn about the expected performance of the textile product in a real world setting.

Exemplary performance characteristics include, but are not limited to: spill resistance, water repellence, water proofing, moisture absorption enhancement or reduction, moisture wicking enhancement, quick drying, stain resistance, soil resistance, antimicrobial properties, breathability, odor resistance, wrinkle resistance, flame retardance, resistance to thermal changes, resistance to dust mites or other microbes, fragrance releasing, fragrance resistance, abrasion resistance, degradation resistance, dye durability, UV blocking and promotion of wound healing.

The educational tool can take the form of a business card, or other surface to which the textile sample can be attached, and the description of the enhanced performance characteristic can be printed. The surface may also include business information such as company logos, addresseses, and phone numbers, etc.

The present invention also relates to an educational method for educating a person about the enhanced performance characteristics of a textile product, usually a consumer, by: providing a textile product having a performance characteristic such as spill resistance, providing instructions or means to carry out a challenge to the enhanced performance characteristic such as a spill sample, and then allowing the consumer to “challenge” the spill resistance by depositing the spill sample onto the textile product or sample thereof, and then view the challenged textile product. Usually, this method is carried out in the retail store in which the consumer may actually make a decision about purchasing the textile product based on the demonstration. However, as will be explained, the present invention is not so limited.

In another embodiment, an exemplary educational tool assembly is provided for demonstrating an enhanced performance characteristic such as spill resistance of a textile product. Such assembly may optionally comprise: a first portion and a second portion; a textile sample; and a spill sample, wherein the assembly is configured such that the enhanced spill resistance of the textile sample is demonstrated by contacting the textile sample with the spill sample (i.e. challenging the enhanced performance characteristic) and then viewing the textile sample after being challenged.

Such assembly may be displayed to a customer in a retail store, placed in their shopping bag, or mailed to the customer in his/her home. For example, the assembly may be sent to the customer in a direct mailing (e.g., in a newspaper bag or with a catalogue). In addition, however, the assembly may be used to demonstrate the enhanced performance characteristics of a textile product in any forum, such as a trade show exhibit, as part of a public display, or as part of a private business meeting.

In other embodiments, an in-store display unit is provided for educating consumers by demonstrating an enhanced performance characteristic such as the spill resistance of a textile product using the in-store display. Such an in-store display unit may include a textile sample; a support configured to hold the textile sample; a spill delivery apparatus configured to deposit a spill onto the textile sample; and a spill reservoir, wherein the textile sample is angled such that the spill deposited on the textile sample flows across the textile sample and is received in the spill reservoir, and wherein the spill delivery apparatus retrieves fluid from the spill reservoir to provide for the spill to be delivered onto the textile sample. In addition, such in-store display unit may optionally include a water fountain.

The present methods of educating consumers regarding the enhanced performance characteristics of textile products by demonstrating their performance characteristics after challenging them are particularly advantageous in that they teach the consumers about the performance characteristics in an easily visualized manner, thus providing evidence of the performance characteristic that the consumer can interpret in evaluating the value of the performance characteristic. Usually, such performance characteristics are invisible to the naked eye and are not detectable by touch, but the effects of challenging the performance characteristics are readily visible. The consumer thus has the opportunity to physically “feel” the textile, and/or view the effects of the challenge, such as a spill on the textile's surface.

In one aspect, the consumer may compare the enhanced performance characteristics of the textile sample to an untreated (i.e. unenhanced or non-high performance) textile sample. Alternately, the consumer may simply view the effects of the challenge to the enhanced performance characteristic without comparison to an untreated textile sample.

In one embodiment, the enhancement to the textile product may be making its surface hydrophobic (i.e. water resistant). In such case, the consumer will simply view the spill as it beads on the surface of the textile sample, or watch as it runs off the textile's hydrophobic surface.

In yet another embodiment, the present invention provides a method of educating consumers regarding an enhanced performance characteristic of a textile product, wherein the enhanced performance characteristic is wrinkle resistance. Such method involves: providing a textile sample having wrinkle-resistance as an enhanced performance characteristic; providing a tool and/or instructions on challenging the textile sample by twisting or folding the sample; and allowing the consumer to perform the twisting or folding thereby giving the consumer the opportunity to view the effects of twisting or folding on the textile sample on the creation or prevention of wrinkles.

In still another embodiment, the present invention provides a method of educating consumers regarding an enhanced performance characteristic of a textile product by: providing a textile sample having breathability as the enhanced performance characteristic; providing a source of air (or steam) under pressure to challenge the performance characteristic by penetrating the sample; and allowing the consumer to apply the air to the textile sample to demonstrate how air penetrates the textile sample thereby giving the consumer the opportunity to view the ease and degree to which air penetrates the textile sample.

Alternatively, the present invention provides a method of educating consumers regarding a performance characteristic of a textile product, by: providing a textile sample having flame retardance as the enhanced performance characteristic; providing a flame source such as a match to challenge the performance characteristic by contacting the textile sample with the flame; and allowing the consumer to contact the textile sample with the flame thereby giving the consumer the opportunity to view effects of the flame and resultant smoke generation on the textile sample.

Similarly, the present invention provides a method of educating consumers regarding an enhanced performance characteristic of a textile product, by: providing a textile sample having antistatic properties as the enhanced performance characteristic (and optionally an untreated control sample); providing a material, such as Styrofoam particles or hair, that will stick to a similar textile sample without the enhanced performance characteristic (i.e. the control sample); and allowing the consumer to contact the textile sample (and the control sample) with the material thereby giving the consumer the opportunity to view the attraction of the material to the samples.

In yet another embodiment, the present invention provides a method of educating consumers regarding an enhanced performance characteristic of a textile product, by: providing a textile sample having anti-dust mite properties as the enhanced performance characteristic; providing a dust mite mimic (such as mite-sized particles) for demonstrating the effects of contacting the textile sample with dust mites; and allowing the consumer to contact the textile sample with the dust mite mimic thereby giving the consumer the opportunity to view the effects of dust mite-sized particles on the textile sample.

Another alternate embodiment of the present invention is a method of educating consumers regarding an enhanced performance characteristic of a textile product by: providing a textile sample having UV protection as the enhanced performance characteristic; providing a source of UV light for demonstrating the effectiveness of the textile sample in blocking the UV light passing therethrough; and allowing the consumer to pass UV light through the textile sample thereby giving the consumer the opportunity to view the blocking of UV light by the textile sample.

Other aspects of the invention are described throughout the specification and the claims.

### BRIEF DESCRIPTION OF THE DRAWINGS

FIG. 1 is a container for a spill sample to be worn by a retail sales person.

FIG. 2A is a view of the top and bottom of an exemplary assembly for demonstrating spill-resistance of a textile sample.

FIG. 2B is a top view of the interior of the assembly of FIG. 2A

FIG. 3A is a schematic side elevation view of an in-store display unit for demonstrating spill-resistance of a textile sample.

FIG. 3B is a front elevation view of the in-store display unit of FIG. 3A.

FIG. 4 is an illustration of an assembly for demonstrating spill-resistance of a textile sample distributed in a newspaper bag.

FIG. 5 is an illustration of a business card having a textile sample attached thereto with enhanced performance characteristics.

### DETAILED DESCRIPTION OF THE INVENTION

The present invention provides educational tools and methods in which various performance characteristics of a textile product are demonstrated to a person in order to teach them about the functional properties of the textile product. The “person” may be a retail customer, the retailer, a manufacturer, or any person having a need or a desire to learn more about the characteristics of textile products. As used herein, the term “consumer” refers to anyone who may be interested in purchasing, using, selling or making a textile product.

Usually, the performance characteristics are the result of treatments, or “enhancements”, that the textile product is subjected to at various times during its manufacture, assembly or thereafter. For example, the enhancement may be used to treat fibers before weaving, fabrics during or after weaving, fabrics during or after the drying and finishing process, as well as finished goods during or after construction from textile fabrics. In any case, the enhanced performance characteristic of the textile product (fiber, fabric, clothing, biomedical material, industrial textiles, carpeting, etc.) may include spill-resistant features, waterproof or water repellent properties, moisture absorption properties, moisture wicking properties, stain repellency, quick drying properties, antimicrobial properties, odor resistance properties, wrinkle-free properties, breathability, softness, flame retardant properties, anti-static properties, would healing properties, anti-dust mite properties, UV protection properties, degradative properties, thermal regulation properties, fragrance, and abrasion resistance of the fabric.

In accordance with the present educational tools and methods, the consumer is educated about the performance characteristics of the textile product as a result of a demonstration involving a challenge to the enhanced performance characteristic of the product, while the textile product, or sample thereof, is viewed by the consumer before and after the challenge. Accordingly, the present methods provide information to the consumer about the product characteristics based on the knowledge gained by observing the demonstration, which in turn allows the consumer to make a well-informed purchasing decision.

The challenge to the enhanced performance characteristic is designed to directly or indirectly test the performance characteristic by subjecting the enhanced textile product, or sample thereof, to appropriate physical, chemical, biological, optical, mechanical or other forces (referred to collectively as “environmental forces” herein) from which the enhanced performance characteristic is designed to protect the textile product. For example, if the enhanced performance characteristic is water resistance, the challenge will be contacting the textile product with water. The challenge to the enhanced performance characteristic by subjecting the textile sample to such environmental forces is also referred to herein as an “external environmental challenge”.

Other exemplary combinations of enhanced performance characteristics and challenges thereto are listed below in Table 1:

TABLE 1

| Enhanced Performance | |
|---|---|
| Characteristic | Challenge |
| Spill resistance | Contact sample with a liquid |
| Water repellence | Contact sample with water |
| Water proofing | Contact sample with a column of water |
| | (i.e. a “hydrostatic head”) |
| Moisture absorption | Contact sample with water - liquid or vapor |
| enhancement or reduction | |
| Moisture wicking | Allow water to wick across sample surface |
| enhancement | |
| Quick drying | Contact sample with water |
| Stain resistance | Contact sample with stain-forming substance |
| Soil resistance | Contact sample with soil |
| Antimicrobial properties | Contact with microbe or microbe mimic |
| Breathability | Pass pressurized air through sample |
| Odor resistance | Contact sample with odorous substance |
| Wrinkle resistance | Subject sample to wrinkle-causing physical |
| | forces |
| Flame retardant | Contact sample with flame |
| Resistance to thermal | Subject sample to changes in temperature |
| changes | |
| Resistance to dust mites | Contact sample with mite-sized particles |
| Fragrance releasing | Subject sample to a physical force, such |
| | as a change in temperature or moisture, |
| | or applying friction |
| Fragrance resistance | Contact sample with fragrance |
| Abrasion resistance | Subject sample to abrasive forces |
| Degradation resistance | Subject sample to degradative forces |
| Dye durability | Subject sample to degrading conditions, |
| | such as detergents |
| UV blocking | Pass UV light through sample |
| Promotion of wound | Contact sample or substrate containing same |
| healing | enhancement with a wound |

Whereas most of the enhanced performance characteristics listed above are easily challenged, and the results of the challenge easily viewed with a “live demonstration”, some enhanced performance characteristics are more conveniently challenged in advance and thereafter observed in the form of images (tapes, films, pictures, etc.) or renditions (drawings, samples of textiles before-and-after a challenge, etc.) of demonstrations that took place previously. This form of educational tool is especially helpful where the enhanced performance characteristic functions over a longer time period than would be practically observable in a live demonstration. For example, if the enhanced performance characteristic is wound healing properties, images can be shown to the consumer of the effect of a textile sample exhibiting the enhanced performance characteristic on wound healing over an appropriate time period, such as several days. Such wound healing effects may be demonstrated by using a wound covering (e.g.: band-aid) having one portion containing an antimicrobial agent that is the sample antimicrobial agent used to treat the textile product to impart would healing properties. Similarly, the other enhanced performance characteristics and the effects of challenges thereto can be demonstrated by images, rather than by the performance of actual activities. Such additional enhanced performance characteristics and challenges thereto include, for example: thermal regulation and subjecting the textile sample to a source of heat or cold; durability and subjecting the textile sample to harsh environmental conditions; and abrasion resistance and subjecting the textile sample to an abrasive surface.

In the aforementioned examples, live demonstrations are substituted by pictures or renditions of demonstrations after they have already taken place. One exemplary embodiment of such a rendition is a 3D hologram or “visi-view” device depicting a challenge. Such devices are assembled to allow a person to view a series of before-and-after pictures of a challenge by changing the angle of the device to give the impression of motion or the passage of time. For example, a device can be constructed with a first picture showing a new garment, a second picture showing a stain-forming substance on the garment, a third picture showing a person's hand with a towel wiping the stain-forming substance away, and a fourth picture showing the garment without the stain (which may be the same as the first picture). Each picture is visible at a different angle, and by slowly tilting the device, the pictures are viewed in sequence. Such devices are well known and easily constructed using available materials and methods.

In certain instances, the educational tool and method of the present invention may include other features besides the enhancements and challenges listed in Table 1 above. For example, the spill resistance enhanced performance characteristic may be challenged either by directly depositing a spill sample onto the textile sample or by another type of demonstration method. For instance, a spill sample may be used to demonstrate spill resistant or waterproof properties of the textile (e.g., beading of spill on a hydrophobic surface). Photomicrographs of water beading on the surface of the textile may also be used.

Alternatively, for enhanced stain resistance, the spill can contain a staining compound, that can be wiped off the textile sample by the customer after depositing the spill on the textile sample, or cleaned off the fabric with an everyday cleaning solvent. For enhanced quick drying, the spill can be deposited and the time to achieve dryness can be observed in comparison with a similar unenhanced textile sample.

For moisture absorption and/or moisture wicking properties, the spill can be deposited and the time it takes to be absorbed into the textile sample can be observed in comparison with a similar unenhanced textile sample. In the case of enhanced wicking properties, use of a colored spill sample will visually assist in showing how the spill is pulled up or across the textile sample. A non-colored spill may also be used.

For odor resistance, a spill containing an odorant can be placed on the textile sample, and then the sample can be sniffed to detect the presence of odor. Alternately, a color change on the textile may signal that the odor has been neutralized. Such color change system may also be used to display antimicrobial performance characteristics of textile products to consumers.

Other enhanced performance characteristics that may be demonstrated to the consumer do not require that a spill be deposited on the textile. In accordance with the present invention, such enhanced performance characteristics are demonstrated by providing a textile sample and allowing the consumer to challenge the enhanced performance characteristic on their own.

For example, such performance characteristics that do not require a spill be made onto the textile sample include, but are not limited to wrinkle-free and abrasion resistance properties; softness; fragrance; enhanced breathability; anti-static properties; flame retardance, anti-dust mite properties; UV protection; wound healing; and degradation of the textile over time.

Accordingly, the wrinkle-free properties of a textile sample may be demonstrated by twisting or folding the textile sample to show that it does not take on wrinkles. Alternatively, the textile sample may be treated on one half with a washing demonstration showing that the treated side of the textile is noticeably less wrinkled.

Abrasion resistance properties may be demonstrated by subjecting the textile sample to abrasion to show that the treatment is still there after multiple abrasions.

Softness may be demonstrated by touching the textile sample.

Fragrance resistance or enhancement may be demonstrated by sniffing the textile sample.

Breathability may be demonstrated by blowing air or smoke through the textile sample.

Flame retardance may be demonstrated by subjecting the textile sample to a flame.

Anti-dust mite properties may be demonstrated by providing dust mite mimics that can be observed on the textile sample (e.g.: by looking under a magnifying glass).

UV protection properties may be demonstrated by demonstrating the degree to which UV light passage has been blocked by the textile.

Wound healing properties may be demonstrated by displaying images that depict enhanced wound healing resulting from application of the textile product or application of the same enhancement with which the textile product was treated.

Resistance to degradation may be demonstrated by displaying images that show how the textile sample reacts to environmental conditions over time. In addition, the textile sample can be displayed in a degradation-promoting environment such as a terrarium.

In one aspect, the present invention provides a method of educating consumers about the performance characteristics of a textile product at a retail site in which a sales person at a retail store demonstrates the performance characteristic of a textile sample to potential customers in a retail store. This method of on-site education of consumers in a retail store location by a sales attendant is designed to provide the consumer with information that would be useful to decide whether or not to purchase the product. In one aspect, it may result in a increase in product sales.

For example, this form of on-site education may involve having the sales person provide a textile sample to a potential customer in a retail store; having the sales person deposit a spill sample onto the textile sample; and then having the customer view the effects of the spill on the textile sample.

What follows is a detailed description of the Figures that depict exemplary embodiments of the practice of the present invention in the context of an educational too and methods for teaching individuals, and in particular potential customers in a retail environment, about the enhanced performance characteristics of textile products.

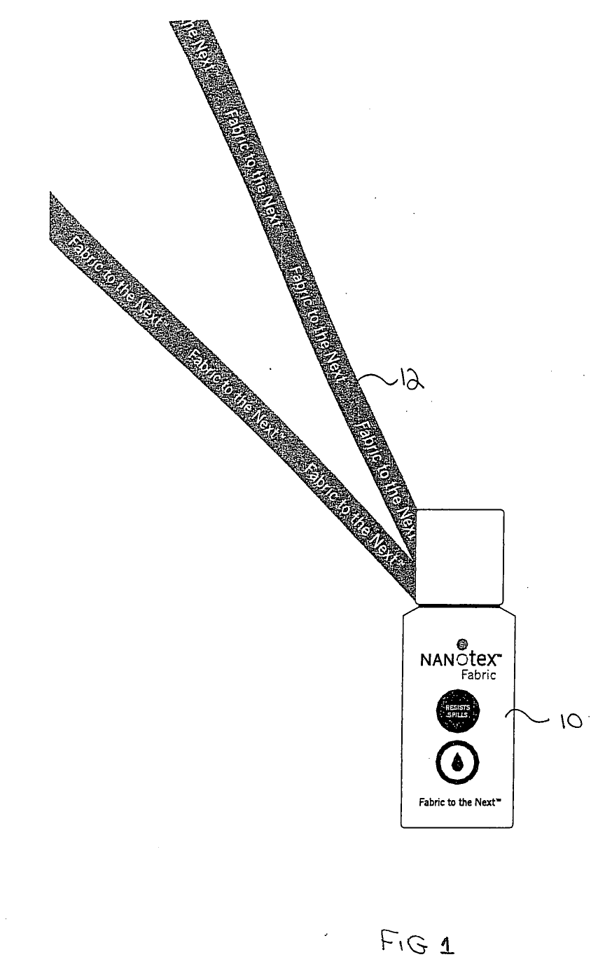

FIG. 1 illustrates a bottle 10 with a neckband 12 that is worn by a sales attendant in a retail store. Bottle 10 contains a spill sample such as water. As depicted, bottle 10 also indicates one enhanced performance characteristic of the textile product—“resists spills”. Optionally, the spill sample may include other aqueous compounds, including, but not limited to, oil based compounds, including ethanol and dyes, and/or odor releasing compounds. In one aspect of the invention, the textile product is a garment such as pants, shirts, etc. In accordance with one embodiment of the methods described herein, the sales attendant approaches various potential customers in the retail store where the product is sold. The sales attendant then invites the customers to view the spill being placed onto the textile product (i.e. the challenge to the enhanced performance characteristic) and to visualize the performance of the textile product as a result of the challenge. The spill may alternately be deposited on a small (hand held) sample of the textile product, or it may be splashed directly onto the textile product (e.g., items of clothing) that are sold to the customer. As described, one of the features of the present invention that makes it ideally suited for educating consumers is the ability to connect the written indicia describing the enhanced performance characteristic to the challenge designed to demonstrate the ability of the textile product (or sample thereof) to respond to the challenge. As such, the consumer is effectively taught precisely how the enhanced performance characteristic affects the performance of the textile product in a real world setting.

In one aspect, the textile product includes (but is not limited to) textile products with spill resistance as the enhanced performance characteristic, such as those developed by Nano-Tex™, L.L.C. of Emeryville, Calif. Other examples of enhanced performance characteristics are waterproof or stain-resistant textile products specifically engineered with a hydrophobic surface. Thus, when the spill sample is deposited on the textile product or sample, the spill sample will either bead on the surface, or alternatively, run off the surface of the textile product without being absorbed into the textile product.

In alternative aspects, moisture wicking or moisture absorbance characteristics of the textile product are demonstrated by observing the movement or absorption of the spill on the textile sample. Stain repellence can also be demonstrated to the consumer by applying a spill containing a staining compound, and then wiping the spill off of the surface of the textile sample. The applicants believe the ability of the potential consumer to both see and touch the textile sample and to witness a challenge to its performance characteristics will educate the consumer about the performance of the textile product in a real world setting, and thereby significantly improve the ability of the consumer to make an informed decision about purchasing. It would thus be expected that if the textile product performed well after being challenged, an increase in retail sales would naturally follow. Such effect is expected to be especially significant when the customer or retailer challenges the enhanced performance characteristic and the customer is able to visualize the results while being in the retail store where the textile product is actually sold.

As discussed above, the present educational method of demonstrating enhanced performance characteristics of a textile product to a consumer may be practiced by: providing a consumer with a textile product (or sample thereof) having an enhanced performance characteristic; providing a spill sample; and allowing the consumer to challenge the enhanced performance characteristic by depositing the spill sample onto the textile sample, and then view effects of the spill on the textile sample. In accordance with the present invention, various assemblies and in-store displays are provided to accomplish this.

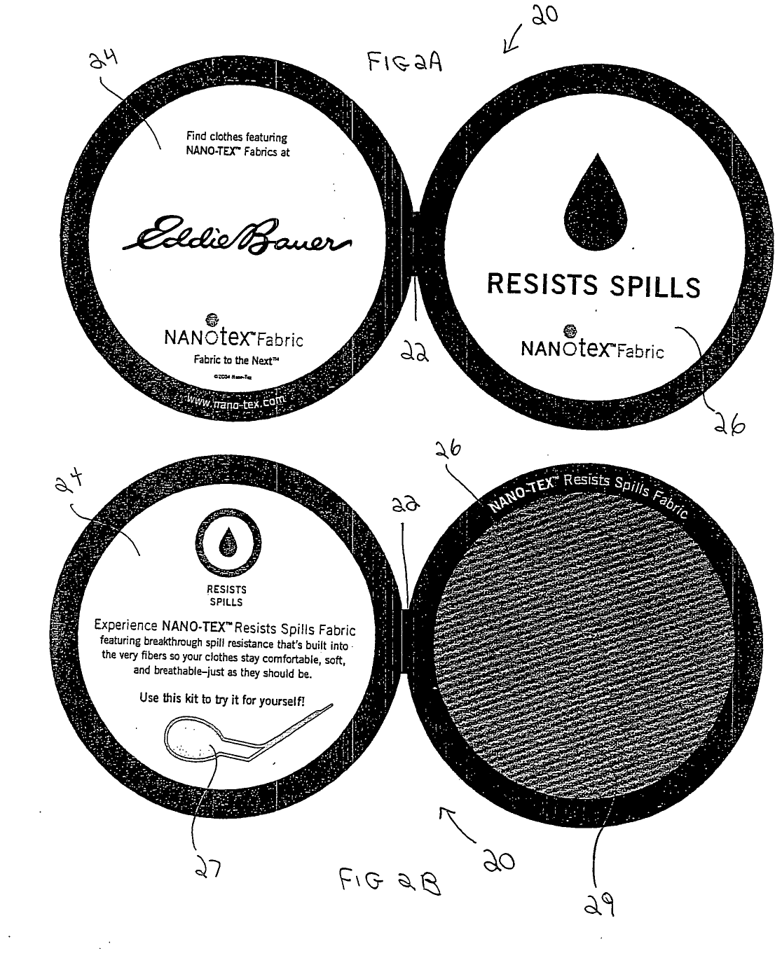

For example, FIGS. 2A and 2B illustrate an assembly 20 that is hinged together at fold 22. Assembly 20 has a top 24 and a bottom 26 that may optionally be made of a treated paper product. As seen in FIG. 2A, top 24 and bottom 26 may be labeled with a manufacturers' (e.g.: Nano-Tex™) logos, trade marks or advertising, and/or a distributor's (e.g.: Eddie Bauer™) logos, trade marks or advertising. The interior of assembly 20 is seen in FIG. 2B, where a spill sample is provided. Such spill sample may simply contain water, but other fluids may be added/substituted as well, as described elsewhere hereon. Also, as shown in FIG. 2A and 2B, the assembly clearly includes indicia describing the enhanced performance characteristic of the textile sample (i.e. resists spills). As would be understood, more than one enhanced performance characteristic may be described on the assembly to indicate that the textile sample and thus the textile product has been treated to impart more than one enhanced performance characteristic. A removable dropper 27 containing the spill sample therein may also be part of the assembly. The other side (i.e., bottom 26) of assembly 20 comprises a sample of the spill-resistant textile 29 attached thereto.

In operation, the customer removes dropper 27 from top 24. The spill in dropper 27 is then squeezed out and placed directly onto textile sample 29. In various embodiments, top 24 and bottom 26 may be folded together when presented to a customer/retailer.

The customer observes the spill sitting on textile sample 29. In embodiments of the invention in which textile sample 29 has a hydrophobic surface which imparts the enhanced performance characteristic of being resistant to spills, the spill will simply bead on the surface of textile sample 29 when textile sample 29 is held level (or run off of textile sample 29 when the sample is held at a angle). In other embodiments, as described above, other performance features of the textile product may be observed by the customer/retailer.

A number of assemblies 20 may optionally be prominently displayed for customer use in a retail store at various locations, including near where the product is sold, or at the checkout counter. Signage, pamphlets, or other written indicia inviting the customer to “try out the spill test” of the product may also be displayed at various locations throughout the retail store. Such assemblies and signage encourage the customer to use the educational tool to perform the educational method to learn more about the expected performance of the textile product in a real world setting before purchasing.

It is to be understood that assembly 20 is merely exemplary, and not limiting. Other sizes and dimensions of such an assembly are included within the scope of the present invention. For example, the assembly need not be round, nor does it need to be folded over upon itself.

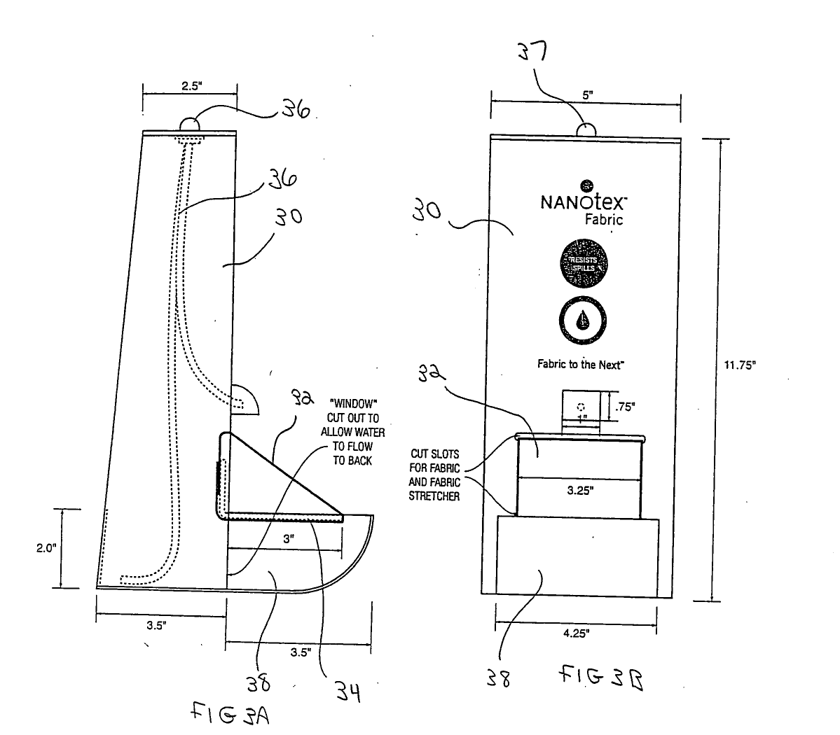

FIGS. 3A and 3B provide an alternate system for demonstrating spill-resistance of a textile sample to a customer by way of an in-store display unit, as follows. In-store display unit 30 includes a textile sample 32; a support 34 configured to support textile sample 32; a spill delivery apparatus 36 configured to deposit a spill onto textile sample 32; and a spill reservoir 38.

In exemplary embodiments, textile sample 32 is angled (as shown) such that the spill deposited thereon flows across the textile sample and is received into spill reservoir 38. In other embodiments, spill delivery apparatus 36 retrieves fluid from spill reservoir 38 to form the spill that is delivered onto textile sample 32. In such embodiments, spill delivery apparatus 36 includes a pump configured to draw fluid from spill reservoir 38 and deposit the fluid on textile sample 32, and an activation button 37 that causes spill delivery apparatus 36 to place a fluid spill onto textile sample 32. In various other embodiments, the textile sample 32 has a hydrophobic surface, and thus any fluid deposited thereon will simply run off of the surface of textile sample 32, and be retrieved in reservoir 38.

In one example, display unit 30 is configured to be displayed on a counter top in a retail store, such as on a counter top near where the textile product is sold or near the checkout counter.

In various aspects, the spill sample in reservoir 38 may include water, an oil based aqueous composition, and/or dyes. Also, display unit 30 may include a manufactures' or a distributor's logos, trade marks or advertising.

In accordance with the present method, display unit 30 may be used such that the customer is invited both to view the effects of the spill on the textile sample 32 and to touch textile sample 32, thus educating the customer regarding the performance characteristics of textile sample 32.

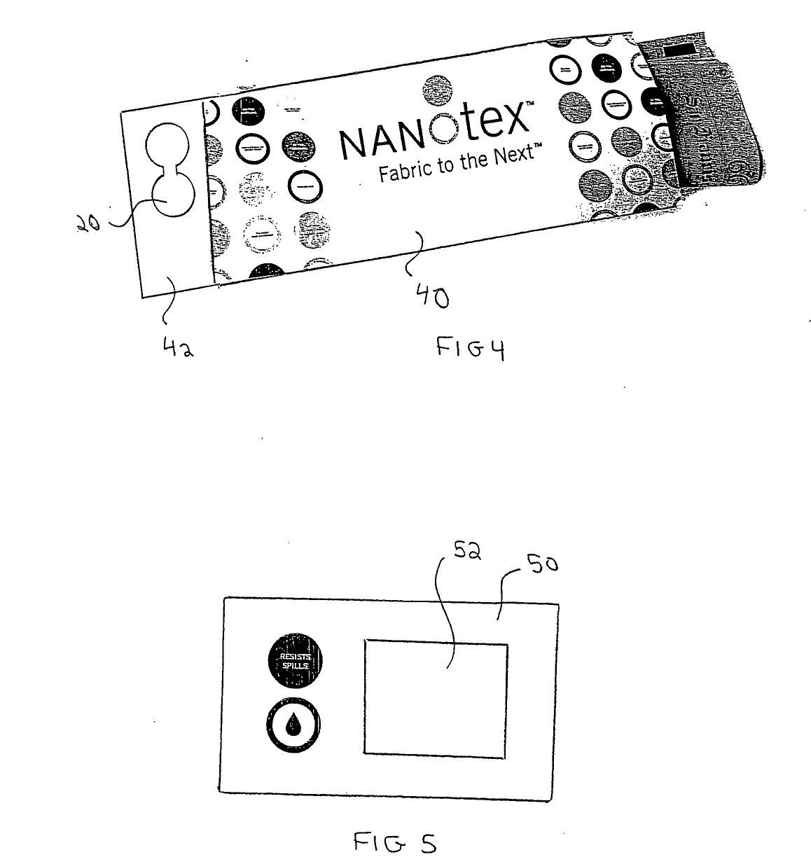

In an alternate aspect of the method of demonstrating the spill-resistance of a textile sample to a customer, assembly 20 as depicted in FIGS. 2A and 2B is sent to potential customers by direct mailing. For example, assembly 20 may be placed into a tear-open bottom portion of a standard newspaper bag (See FIG. 4, where assembly 20 is placed in tear-open bottom portion 42 of newspaper bag 40).

The present invention also includes a business card system that is useful for demonstrating the enhanced performance characteristics of the textile sample to a consumer. The business card system has the advantage of being conveniently given to the consumer. Thus, the consumer may perform the educational method by challenging the textile sample again and again (by simply spilling fluid on the textile sample).

Accordingly, referring to FIG. 5, a business card 50 is provided with a textile sample 52 attached directly thereto to the back side of the business card. The textile sample may cover one entire side of business card 50, or it may only cover a portion of one side of business card 50 (as illustrated). Also as shown, the business card assembly includes indicia stating the enhanced performance characteristic of the textile sample, i.e. spill resistance. In various embodiments, other indicia may be printed on either or both sides of the business card. Such indicia may include a manufacturer's or distributor's contact information, logos, trade marks or advertising

The information presented above is provided to give those of ordinary skill in the art with a complete disclosure and description of how to make and use the preferred embodiments of the invention, and is not intended to limit the scope of what the inventor(s) regard(s) as his or her/their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

What is claimed is:

1. An educational tool assembly for demonstrating at least one enhanced performance characteristic of a textile product to a person comprising:
a. a textile sample having the same enhanced performance characteristic of the textile product attached to the assembly, wherein the assembly is adapted for demonstrating the enhanced performance characteristic using an external environmental challenge to the enhanced performance characteristic; and
b. a description of the enhanced performance characteristic of the textile sample on the assembly.

2. The educational tool assembly of claim 1, wherein the enhanced performance characteristic is selected from the group consisting of: spill resistance, water repellence, water proofing, moisture absorption enhancement or reduction, moisture wicking enhancement, quick drying, stain resistance, soil resistance, antimicrobial properties, breathability, odor resistance, wrinkle resistance, flame retardance, resistance to thermal changes, resistance to dust mites or other microbes, fragrance releasing, fragrance resistance, abrasion resistance, degradation resistance, dye durability, UV blocking and promotion of wound healing.

3. The educational tool assembly of claim 1 in the form of a business card which further comprises indicia associated with a business entity, and wherein the textile sample is attached to at least one side of the business card.

4. The educational tool assembly of claim 3, wherein the textile sample is attached to a first side of the business card and the indicia associated with a business entity is attached to a second side.

5. The educational tool assembly of claim 3, wherein the textile sample and the description of the enhanced performance characteristic are on a single side of the business card.

6. The educational tool assembly of claim 3 further comprising indicia of a manufacturer's logo.

7. The educational tool assembly of claim 3 further comprising indicia of a distributor's logo.

8. A method for educating a person about an enhanced performance characteristic of a textile product comprising the steps of:
a. providing the textile product or a sample thereof with the enhanced performance characteristic; and
b. subjecting the textile product or sample thereof to an external environmental challenge to the enhanced performance characteristic.

9. The method of claim 8, further comprising the step of mailing the textile sample and instructions and/or means for carrying out step b. to the person.

10. The method of claim 8, further comprising the step of providing a textile sample, and instructions and/or means for carrying out the challenge for carrying out step b., in a bag with a newspaper.

11. The method of claim 8, wherein the external environmental challenge is contacting the textile product or sample thereof with a spill sample.

12. The method of claim 11, wherein the person is a consumer and steps a. and b. are carried out in a retail store.

13. The method of claim 12, wherein step b. is performed by a sales person in the retail store.

14. The method of claim 13, wherein the sales person carries the spill sample around the retail store.

15. The method of claim 8, wherein the enhanced performance characteristic is wrinkle resistance, and wherein the external environmental challenge further comprises twisting or folding the textile product or sample thereof.

16. The method of claim 8, wherein the enhanced performance characteristic is breathability, and wherein the external environmental challenge further comprises passing air through the textile product or sample thereof.

17. The method of claim 8, wherein the enhanced performance characteristic is flame retardance, and wherein the external environmental challenge further comprises contacting the textile product or sample thereof with a flame.

18. A method for educating a person about the enhanced performance characteristics of a textile product, comprising the steps of:
a. providing a textile sample having the same enhanced performance characteristic of the textile product;
b. providing means to implement a challenge to the enhanced performance characteristic;
c. allowing the person to implement the challenge; and
d. allowing the person to observe the enhanced performance characteristic of the textile sample after the challenge.

19. The method of claim 18, wherein the means to implement the challenge comprises a spill sample, and wherein the person is instructed to deposit the spill sample onto the textile sample.

20. The method of claim 19, wherein the person is a customer in a retail store.

21. The method of claim 18, wherein the textile sample and the spill sample are part of an assembly further comprising written indicia instructing the customer to deposit the spill sample onto the textile sample, and wherein step c. further comprises removing the spill sample from the assembly and placing the spill sample onto the textile sample.

22. The method of claim 19, wherein the spill sample is contained within a removable fluid dropper.

23. The method of claim 21, wherein the assembly is displayed in a retail store.

24. The method of claim 21, wherein the assembly further comprises an in-store display unit configured to implement the challenge, and wherein the in-store display unit further comprises:
a. a support configured to hold the textile sample;
b. a spill delivery apparatus configured to deposit the spill sample onto the textile sample as the means to implement the challenge to the enhanced performance characteristic; and
c. a spill reservoir, wherein the textile sample is angled such that the spill deposited on the textile sample flows across the surface of the textile sample and is received in the spill reservoir,
wherein the spill delivery apparatus retrieves fluid from the spill reservoir to provide for the spill sample to be delivered onto the textile sample.

25. An educational tool assembly for demonstrating at least one enhanced performance characteristic of a textile product to a person comprising:
a. a first portion having a textile sample disposed therein; and
b. a second portion having a spill sample disposed therein;
wherein the assembly is configured to implement a challenge to the enhanced performance characteristic by placing the spill sample onto the textile sample.

26. The assembly of claim 25, wherein the spill sample is contained in a removable fluid dropper in the second portion of the assembly.

27. The assembly of claim 25, wherein the first portion and the second portion are hinged together.

28. The assembly of claim 25, wherein the enhanced performance characteristic is selected from the group consisting of: spill resistance, water repellence, water proofing, moisture absorption enhancement or reduction, moisture wicking enhancement, quick drying, stain resistance, soil resistance, antimicrobial properties, breathability, odor resistance, wrinkle resistance, flame retardance, resistance to thermal changes, resistance to dust mites or other microbes, fragrance releasing, fragrance resistance, abrasion resistance, degradation resistance, dye durability, UV blocking and promotion of wound healing.

29. The assembly of claim 25, wherein the spill sample comprises an aqueous solution.

30. The assembly of claim 29, wherein the aqueous solution is water.

31. The assembly of claim 25, wherein the spill sample comprises an oil based liquid solution.

32. The assembly of claim 25, wherein the spill sample comprises an alcohol based liquid solution.

33. The assembly of claim 25, wherein the spill sample comprises a dye in a liquid solution.

34. The assembly of claim 25 further comprising indicia of a manufacturer's logo.

35. The assembly of claim 25 further comprising indicia of a distributor's logo.

36. The assembly of claim 25, wherein the textile sample has a hydrophobic surface.

37. An educational tool assembly for demonstrating at least one enhanced performance characteristic of a textile product to a person, wherein the assembly is adapted for display in a retail store, wherein the assembly comprises:
a. a textile sample having the same enhanced performance characteristic as the textile product;
b. a support configured to hold the textile sample;
c. a spill delivery apparatus configured to deposit the spill sample onto the textile sample to implement an external environmental challenge to the enhanced performance characteristic; and
d. a spill reservoir, wherein the textile sample is angled such that the spill deposited on the textile sample flows across the surface of the textile sample and is received in the spill reservoir,

38. The in-store display unit of claim 37, wherein the spill delivery apparatus further comprises a pump configured to draw fluid from the spill reservoir and deposit the fluid onto the textile sample.

39. The in-store display unit of claim 37 configured to be placed on a countertop.

40. The in-store display unit of claim 37 configured to be activated by a customer in a retail store.

41. The in-store display unit of claim 37, wherein the spill sample comprises an aqueous solution.

42. The in-store display unit of claim 41, wherein the aqueous solution is water.

43. The in-store display unit of claim 37, wherein the spill sample comprises an oil based liquid solution.

44. The in-store display unit of claim 37, wherein the spill sample comprises an alcohol based liquid solution.

45. The in-store display unit of claim 37, wherein the spill sample comprises a dye in a liquid solution.

46. The in-store display unit of claim 37 further comprising indicia of a manufacturer's logo.

47. The in-store display unit of claim 37 further comprising indicia of a distributor's logo.

48. The in-store display unit of claim 37, wherein the enhanced performance characteristic is selected from the group consisting of: spill resistance, water repellence, water proofing, moisture absorption enhancement or reduction, moisture wicking enhancement, quick drying, stain resistance, soil resistance, antimicrobial properties, breathability, odor resistance, wrinkle resistance, flame retardance, resistance to thermal changes, resistance to dust mites or other microbes, fragrance releasing, fragrance resistance, abrasion resistance, degradation resistance, dye durability, UV blocking and promotion of wound healing.

49. An educational device for demonstrating at least one enhanced performance characteristic of a textile product to a person comprising a series of pictures of the textile product depicting the textile product before and after a challenge to the performance characteristic, wherein the pictures are placed under a ridged laminate adapted for viewing the pictures in sequence when the device is moved relative to a line of sight from the person.
